(19) United States
(12) Patent Application Publication
(10) Pub. No.: US 2026/0146521 A1
(43) Pub. Date: May 28, 2026

(54) AUTOMATED BLEED-OFF SYSTEM FOR A FLUID SYSTEM

(71) Applicant: SPM Oil & Gas Inc., Fort Worth, TX (US)

(72) Inventors: Jamil Jacaman, Fort Worth, TX (US); Logan Nerren, Fort Worth, TX (US); Brian Witkowski, Weatherford, TX (US)

(73) Assignee: SPM Oil & Gas Inc., Fort Worth, TX (US)

(21) Appl. No.: 18/963,248

(22) Filed: Nov. 27, 2024

(51) Int. Cl. E21B 43/26; G05D 16/20

(52) U.S. Cl. CPC E21B 43/2607; G05D 16/204

(57) ABSTRACT

An automated bleed-off system for a hydraulic fracturing system may include a bleed-off manifold that includes one or more fluid inputs to receive pressurized fluid from the hydraulic fracturing system, a bleed-off line fluidly coupling the one or more fluid inputs to an output, and a plurality of isolation valves to control flow through the one or more fluid inputs and the bleed-off line. The automated bleed-off system may include a valve greasing system that includes a grease reservoir to hold grease, and a grease conduit fluidly coupling the grease reservoir to an isolation valve of the plurality of isolation valves. The automated bleed-off system may include a control system that includes a valve actuator, including an actuation sensor, to control actuation of the isolation valve, and a controller configured to cause actuation of one or more of the plurality of isolation valves to bleed-off pressure via the bleed-off line.

### TECHNICAL FIELD

The present disclosure relates generally to fluid systems and, for example, to an automated bleed-off system for a fluid system.

### BACKGROUND

Hydraulic fracturing is a well stimulation technique that typically involves pumping hydraulic fracturing fluid into a wellbore at a rate and a pressure (e.g., up to 15,000 pounds per square inch (psi)) sufficient to form fractures in a rock formation surrounding the wellbore. This well stimulation technique often enhances the natural fracturing of a rock formation to increase the permeability of the rock formation, thereby improving recovery of water, oil, natural gas, and/or other fluids. In a hydraulic fracturing operation, pressurized fluid and proppants may be pumped into the wellbore in a series of stages. Following a stage, the pressurized fluid may be bled from the system to allow for various well completion activities (e.g., wireline activities) to be performed in the wellbore. Generally, in a bleed-off operation, one or more valves are manually opened and closed when a target pressure is reached. This manual approach is imprecise and inconsistent, which can lead to unintended rapid depressurization and damage to components of the hydraulic fracturing system. Moreover, the valves should receive frequent greasing to improve their longevity. However, a timing for greasing the valves is often subject to operator discretion, which can result in lengthy intervals between greasings that can shorten a useful life of the valves.

The automated bleed-off system of the present disclosure solves one or more of the problems set forth above and/or other problems in the art.

### SUMMARY

An automated bleed-off system for a hydraulic fracturing system may include a bleed-off manifold. The bleed-off manifold may include one or more fluid inputs to receive pressurized fluid from the hydraulic fracturing system, a bleed-off line fluidly coupling the one or more fluid inputs to an output, and a plurality of isolation valves to control flow through the one or more fluid inputs and the bleed-off line. The automated bleed-off system may include a valve greasing system that includes a grease reservoir to hold grease, and a grease conduit fluidly coupling the grease reservoir to an isolation valve of the plurality of isolation valves. The automated bleed-off system may include a control system that includes a valve actuator, including an actuation sensor, to control actuation of the isolation valve, and a controller configured to cause actuation of one or more of the plurality of isolation valves to bleed-off pressure via the bleed-off line.

A bleed-off manifold for a hydraulic fracturing system may include a first fluid input to receive pressurized fluid from a pump side of the hydraulic fracturing system. The pump side is upstream of a valve, in a conduit of the hydraulic fracturing system, that is between one or more pumps and one or more wells of the hydraulic fracturing system. The bleed-off manifold may include a second fluid input to receive pressurized fluid from a well side of the hydraulic fracturing system. The well side is downstream of the valve. The bleed-off manifold may include a bleed-off line fluidly coupling the first fluid input and the second fluid input to an output, where the bleed-off line includes a multi-stage choke assembly. The bleed-off manifold may include a bypass line fluidly coupling the first fluid input and the second fluid input to the output, where the bypass line bypasses the multi-stage choke assembly. The bleed-off manifold may include a first isolation valve to control flow through the first fluid input, a second isolation valve to control flow through the second fluid input, a third isolation valve to control flow through the bleed-off line, and a fourth isolation valve to control flow through the bypass line.

A method for automated bleed-off of fluid pressure from a hydraulic fracturing system between stages of a hydraulic fracturing operation may include obtaining, by a controller and after completion of a stage of the hydraulic fracturing operation, an instruction to bleed-off pressure from the hydraulic fracturing system, and causing, by the controller, opening of multiple isolation valves of a bleed-off manifold to bleed-off pressure via a multi-stage choke assembly in a bleed-off line of the bleed-off manifold.

### BRIEF DESCRIPTION OF THE DRAWINGS

FIG. 1 is a diagram illustrating an example hydraulic fracturing system.

FIG. 2 is a perspective view of an example automated bleed-off system.

FIG. 3 is a top view of an example bleed-off manifold.

FIG. 4 is a diagram illustrating an example automated bleed-off system.

FIG. 5 is a flowchart of an example process associated with automated pressure bleed-off.

### DETAILED DESCRIPTION

This disclosure relates to an automated bleed-off system, which is applicable to any system that contains high-pressure fluid. For example, the system may be a hydraulic fracturing system.

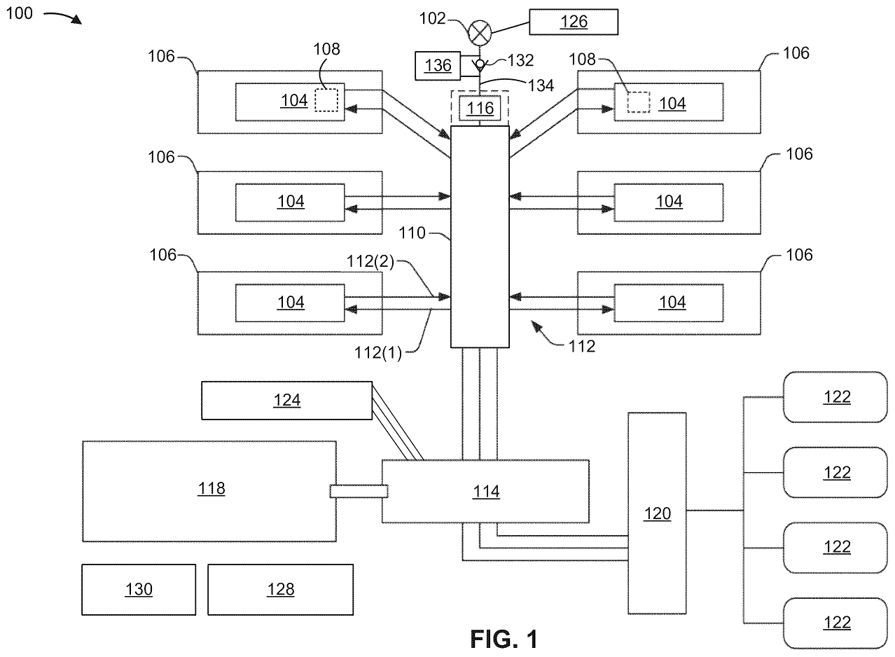

FIG. 1 is a diagram illustrating an example hydraulic fracturing system 100. For example, FIG. 1 depicts a plan view of an example hydraulic fracturing site along with equipment that is used during a hydraulic fracturing process. In some examples, less equipment, additional equipment, or alternative equipment to the example equipment depicted in FIG. 1 may be used to conduct the hydraulic fracturing process.

The hydraulic fracturing system 100 includes a well 102. Hydraulic fracturing is a well-stimulation technique that uses high-pressure injection of fracturing fluid into the well 102 and corresponding wellbore in order to hydraulically fracture a rock formation surrounding the wellbore. While the description provided herein describes hydraulic fracturing in the context of wellbore stimulation for oil and gas production, the description herein is also applicable to other uses of hydraulic fracturing.

High-pressure injection of the fracturing fluid may be achieved by one or more pump systems 104 that may be mounted (or housed) on one or more hydraulic fracturing trailers 106 (which also may be referred to as “hydraulic fracturing rigs”) of the hydraulic fracturing system 100. Each of the pump systems 104 includes at least one fluid pump 108 (referred to herein collectively, as “fluid pumps 108” and individually as “a fluid pump 108”). The fluid pumps 108 may be hydraulic fracturing pumps. The fluid pumps 108 may include various types of high-volume hydraulic fracturing pumps such as triplex or quintuplex pumps. Additionally, or alternatively, the fluid pumps 108 may include other types of reciprocating positive-displacement pumps or gear pumps. A type and/or a configuration of the fluid pumps 108 may vary depending on the fracture gradient of the rock formation that will be hydraulically fractured, the quantity of fluid pumps 108 used in the hydraulic fracturing system 100, the flow rate necessary to complete the hydraulic fracture, the pressure necessary to complete the hydraulic fracture, or the like. The hydraulic fracturing system 100 may include any number of trailers 106 having fluid pumps 108 thereon in order to pump hydraulic fracturing fluid at a predetermined rate and pressure.

In some examples, the fluid pumps 108 may be in fluid communication with a manifold 110 via various fluid conduits 112, such as flow lines, pipes, or other types of fluid conduits. The manifold 110 combines fracturing fluid received from the fluid pumps 108 prior to injecting the fracturing fluid into the well 102. The manifold 110 also distributes fracturing fluid to the fluid pumps 108 that the manifold 110 receives from a blender 114 of the hydraulic fracturing system 100. In some examples, the various fluids are transferred between the various components of the hydraulic fracturing system 100 via the fluid conduits 112. The fluid conduits 112 include low-pressure fluid conduits 112(1) and high-pressure fluid conduits 112(2). In some examples, the low-pressure fluid conduits 112(1) deliver fracturing fluid from the manifold 110 to the fluid pumps 108, and the high-pressure fluid conduits 112(2) transfer high-pressure fracturing fluid from the fluid pumps 108 to the manifold 110.

The manifold 110 also includes a fracturing head 116. The fracturing head 116 may be included on a same support structure as the manifold 110. The fracturing head 116 receives fracturing fluid from the manifold 110 and delivers the fracturing fluid to the well 102 (via a well head mounted on the well 102) during a hydraulic fracturing process. In some examples, the fracturing head 116 may be fluidly connected to multiple wells.

The blender 114 combines proppant received from a proppant storage unit 118 with fluid, which may be received from a hydration unit 120 of the hydraulic fracturing system 100. In some examples, the proppant storage unit 118 may include a dump truck, a truck with a trailer, one or more silos, or other types of containers. The hydration unit 120 receives water from one or more water tanks 122. In some examples, the hydraulic fracturing system 100 may receive water from water pits, water trucks, water lines, and/or any other suitable source of water. The hydration unit 120 may include one or more tanks, pumps, gates, or the like.

The hydration unit 120, or alternatively a chemical adding unit or the blender 114, may add fluid additives, such as polymers or other chemical additives, to the water. Such additives may increase the viscosity of the fracturing fluid prior to mixing the fluid with proppant in the blender 114. The additives may also modify a pH of the fracturing fluid to an appropriate level for injection into a targeted formation surrounding the wellbore. Additionally, or alternatively, the hydraulic fracturing system 100 may include one or more fluid additive storage units 124 that store fluid additives. The fluid additive storage unit 124 may be in fluid communication with the hydration unit 120 and/or the blender 114 to add fluid additives to the fracturing fluid.

In some examples, the hydraulic fracturing system 100 may include a balancing pump 126. The balancing pump 126 provides balancing of a differential pressure in an annulus of the well 102. The hydraulic fracturing system 100 may include a data monitoring system 128. The data monitoring system 128 may manage and/or monitor the hydraulic fracturing process performed by the hydraulic fracturing system 100 and the equipment used in the process. In some examples, the management and/or monitoring operations may be performed from multiple locations. The data monitoring system 128 may be supported on a van, a truck, or may be otherwise mobile. The data monitoring system 128 may include a display for displaying data for monitoring performance and/or optimizing operation of the hydraulic fracturing system 100. In some examples, the data gathered by the data monitoring system 128 may be sent off-board or off-site for monitoring performance and/or performing calculations relative to the hydraulic fracturing system 100.

The hydraulic fracturing system 100 includes a controller 130. The controller 130 may be a system-wide controller for the hydraulic fracturing system 100 or a pump-specific controller for a pump system 104. The controller 130 may be communicatively coupled (e.g., by a wired connection or a wireless connection) with one or more of the pump systems 104. The controller 130 may also be communicatively coupled with other equipment and/or systems of the hydraulic fracturing system 100.

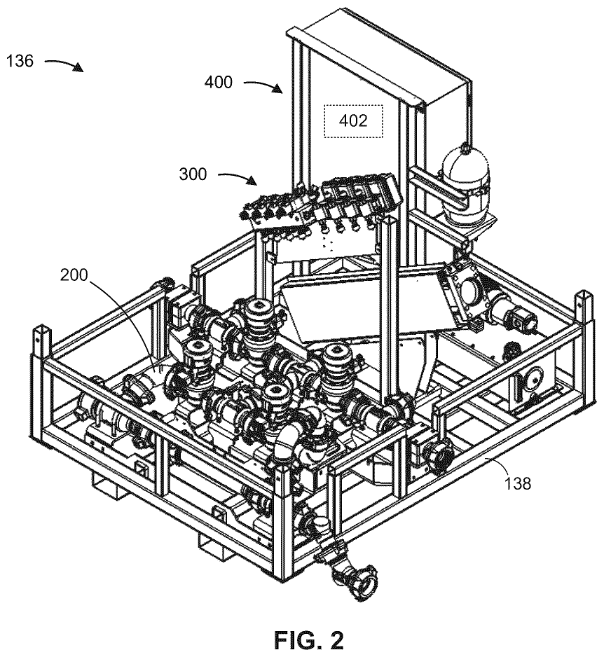

The hydraulic fracturing system 100 may include a valve 132 (e.g., a check valve) in a conduit 134 between the manifold 110 and the well 102. For example, the valve 132 is shown in FIG. 1 downstream of the fracturing head 116. However, in some examples, the valve 132 may be upstream of the fracturing head 116. The valve 132 defines a pump side (which can also be referred to as a “truck side”) of the hydraulic fracturing system 100 upstream of the valve 132, and a well side (which can also be referred to as a “wellhead side”) of the hydraulic fracturing system 100 downstream of the valve 132. The hydraulic fracturing system 100 may include an automated bleed-off system 136 fluidly coupled to the conduit 134 between the manifold 110 and the well 102 to receive pressurized fluid from the hydraulic fracturing system 100. For example, fluid inputs of the automated bleed-off system 136 may be fluidly coupled upstream and downstream, respectively, of the valve 132, as described further in connection with FIG. 2.

As indicated above, FIG. 1 is provided as an example. Other examples may differ from what is described with regard to FIG. 1.

FIG. 2 is a perspective view of an example of the automated bleed-off system 136. The automated bleed-off system 136 may include a bleed-off manifold 200, a valve greasing system 300, and a control system 400 that includes a controller 402. The components of the automated bleed-off system 136 may be mounted in a frame or a housing (e.g., that fully or partially encloses the components). For example, the components of the automated bleed-off system 136 may be mounted on a skid 138, as shown. The skid 138 may include lifting mechanism (e.g., forklift tubes and/or lifting eyelets) to facilitate transport of the automated bleed-off system 136.

As indicated above, FIG. 2 is provided as an example. Other examples may differ from what is described with regard to FIG. 2.

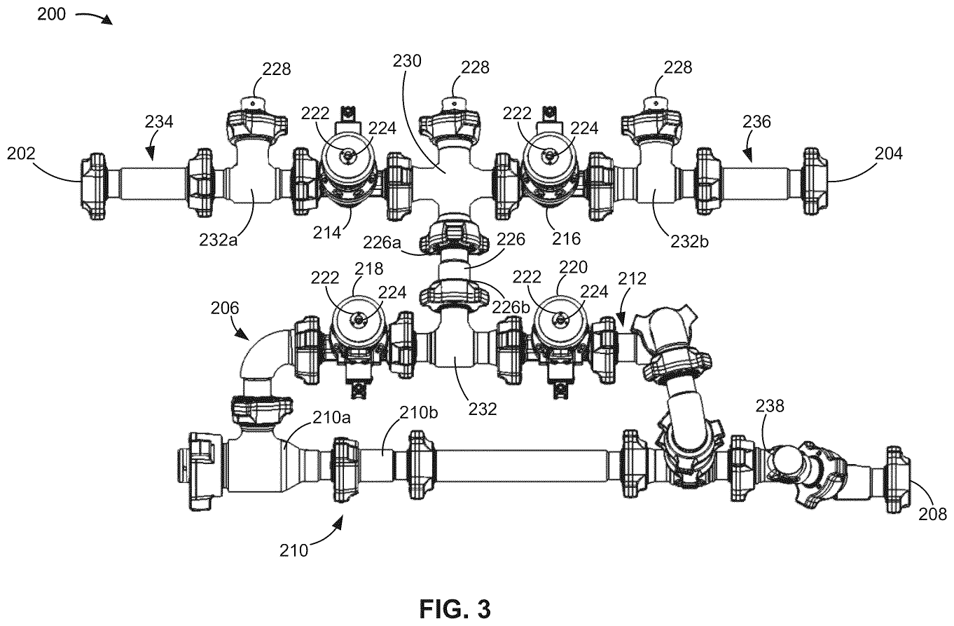

FIG. 3 is a top view of an example of the bleed-off manifold 200. The bleed-off manifold 200 may include one or more fluid inputs 202, 204 to receive pressurized fluid from the hydraulic fracturing system 100, and a bleed-off line 206 fluidly coupling the one or more fluid inputs 202, 204 to an output 208 of the bleed-off manifold 200. For example, the bleed-off manifold 200 may include a first fluid input 202 to receive pressurized fluid from the pump side of the hydraulic fracturing system 100 (i.e., upstream of the valve 132), and a second fluid input 204 to receive pressurized fluid from the well side of the hydraulic fracturing system 100 (i.e., downstream of the valve 132).

The bleed-off line 206 may couple the first fluid input 202 and the second fluid input 204 to the output 208. The bleed-off line 206 may include a multi-stage choke assembly 210 that includes a first choke 210a and a second choke 210b arranged in series. In some examples, the first choke 210a may have an elbow (or 90 degrees) configuration, while the second choke 210b may have an in-line (or straight) configuration. In some examples, the first choke 210a and the second choke 210b may include respective orifices that are fixed, during operation, with respect to a particular flow area that is provided. In other words, whereas orifice hardware may be interchangeable, during a maintenance period, to be configured to provide for certain changes in the flow area, the orifice hardware may be non-adjustable during operation. However, in some other examples, the first choke 210a and the second choke 210b may be adjustable during operation. The first choke 210a and the second choke 210b may include respective orifices having the same opening diameter (e.g., such that the first choke 210a and the second choke 210b provide equivalent pressure reductions to the pressurized fluid). Alternatively, the respective orifices of the first choke 210a and the second choke 210b may have different opening diameters from each other. The multi-stage choke assembly 210 provides a gradual pressure release through the bleed-off line 206, thereby extending a useful life of the bleed-off manifold 200 and of the chokes 210a, 210b. In some implementations, the multi-stage choke assembly 210 may include more than two chokes (e.g., three chokes, four chokes, or five chokes) to provide additionally gradual pressure release.

In some implementations, the bleed-off manifold 200 may include a bypass line 212. The bypass line 212 may couple the first fluid input 202 and the second fluid input 204 to the output 208. The bypass line 212 may provide a fluid path from the inputs 202, 204 to the output 208 that bypasses the bleed-off line 206. In particular, the bypass line 212 may bypass the multi-stage choke assembly 210.

The bleed-off manifold 200 may include a plurality of isolation valves 214, 216, 218, and 220. The isolation valves 214, 216, 218, and 220 may control fluid flow through the fluid inputs 202, 204, the bleed-off line 206, and/or the bypass line 212. For example, the bleed-off manifold 200 may include a first isolation valve 214 to control flow through the first fluid input 202, a second isolation valve 216 to control flow through the second fluid input 204, a third isolation valve 218 to control flow through the bleed-off line 206, and a fourth isolation valve 220 to control flow through the bypass line 212. The isolation valves 214, 216, 218, and 220 may be plug valves or another type of valve.

Each isolation valve 214, 216, 218, 220 may include a valve actuator 222 to control actuation (e.g., opening and closing) of the isolation valve. A valve actuator 222 may provide automated actuation of an isolation valve using a hydraulic, pneumatic, or electronic actuation mechanism. Each valve actuator 222 may include an actuation sensor 224 (e.g., a position sensor) configured to detect actuation of an isolation valve. For example, an actuation sensor 224 may measure a degree of actuation of an isolation valve (e.g., 20% open, 50% open, 80% open, etc.), or simply whether the isolation valve has been actuated (e.g., whether the valve has been opened or closed). In some examples, the bleed-off manifold 200 may include a first valve actuator 222, with a first actuation sensor 224, to control actuation of the first isolation valve 214, a second valve actuator 222, with a second actuation sensor 224, to control actuation of the second isolation valve 216, a third valve actuator 222, with a third actuation sensor 224, to control actuation of the third isolation valve 218, and a fourth valve actuator 222, with a fourth actuation sensor 224, to control actuation of the fourth isolation valve 220.

In some examples, the bleed-off manifold 200 may include a connection conduit 226. The fluid inputs 202, 204 may be fluidly coupled to an input end 226a of the connection conduit 226. The bleed-off line 206 and the bypass line 212 may be fluidly coupled to an output end 226b of the connection conduit 226. In this way, the connection conduit 226 enables distribution of fluid from either of the first fluid input 202 or the second fluid input 204 to either of the bleed-off line 206 or the bypass line 212 (e.g., depending on which isolation valves 214, 216, 218, 220 are open).

In some examples, the bleed-off manifold 200 may include one or more pressure sensors 228 (e.g., pressure transducers) to measure pressures in the bleed-off manifold 200. For example, the bleed-off manifold 200 may include a first pressure sensor 228, which may be positioned between the first fluid input 202 and the first isolation valve 214, to measure a pressure at the first fluid input 202. The bleed-off manifold 200 may include a second pressure sensor 228, which may be positioned between the second fluid input 204 and the second isolation valve 216, to measure a pressure at the second fluid input 204. The bleed-off manifold 200 may include a third pressure sensor 228, which may be positioned between the first isolation valve 214 and the second isolation valve 216, to measure a pressure between the first isolation valve 214 and the second isolation valve 216 (e.g., a pressure in the connection conduit 226). As another example, the third pressure sensor 228 can be used to detect whether the first isolation valve 214 and/or the second isolation valve 216 has a leak.

In one configuration, the bleed-off manifold 200 may include a four-way connector 230 (e.g., a cross connector) and a three-way connector 232 (e.g., a tee connector) that couple conduits of the bleed-off manifold 200. A conduit 234 that includes the first fluid input 202, the first pressure sensor 228 (e.g., coupled in the conduit 234 by an additional three-way connector 232a), and the first isolation valve 214 may be fluidly coupled to a first port of the four-way connector 230. A conduit 236 that includes the second fluid input 204, the second pressure sensor 228 (e.g., coupled in the conduit 236 by an additional three-way connector 232b), and the second isolation valve 216 may be fluidly coupled to a second port of the four-way connector 230 (e.g., that is opposite the first port). The third pressure sensor 228 may be fluidly coupled to a third port of the four-way connector 230. The input end 226a of the connection conduit 226 may be fluidly coupled to a fourth port of the four-way connector 230 (e.g., opposite the third port), and the output end 226b of the connection conduit 226 may be fluidly coupled to a first port of the three-way connector 232. The bleed-off line 206, including the third isolation valve 218, may be fluidly coupled to a second port of the three-way connector 232. The bypass line 212, including the fourth isolation valve 220, may be fluidly coupled to a third port of the three-way connector 232 (e.g., opposite the second port). The bleed-off line 206 and the bypass line 212 may converge at a conduit 238 that terminates at the output 208. Various components of the bleed-off manifold 200 described herein may be connected to each other by threaded connections or another type of connection that provides fluid tightness.

As indicated above, FIG. 3 is provided as an example. Other examples may differ from what is described with regard to FIG. 3.

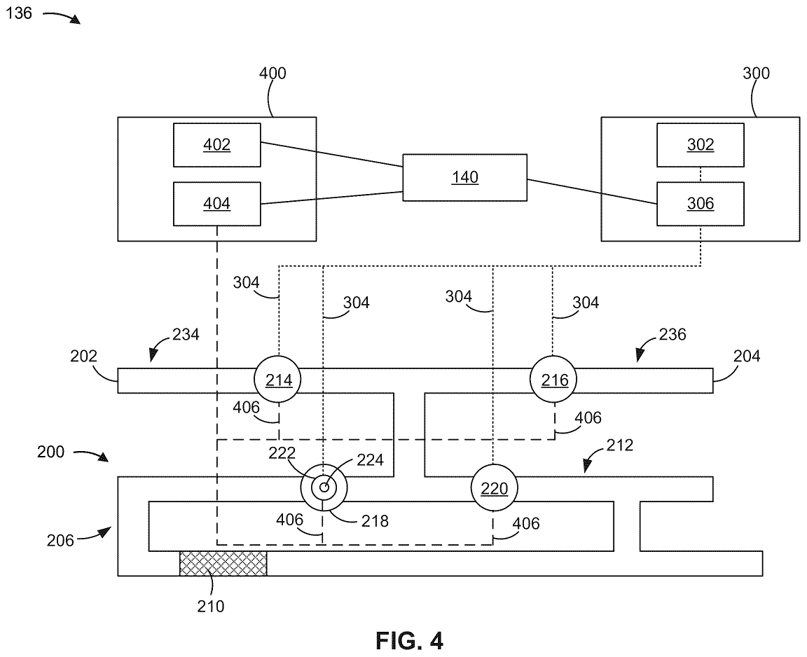

FIG. 4 is a diagram illustrating an example of the automated bleed-off system 136. As described herein, the automated bleed-off system 136 may include the bleed-off manifold 200, the valve greasing system 300, and the control system 400.

The valve greasing system 300 may include a grease reservoir 302 to hold a quantity of grease used for greasing the isolation valves 214, 216, 218, 220 of the bleed-off manifold 200. The valve greasing system 300 may include a plurality of grease conduits 304 in fluid communication with the isolation valves 214, 216, 218, 220 and fluidly coupled to the grease reservoir 302. The valve greasing system 300 may include a pump 306 configured to pump grease from the grease reservoir 302 through the grease conduits 304. The valve greasing system 300 may additionally include one or more valves (not shown) for controlling the flow of grease through the grease conduits 304.

The control system 400 may provide control over actuation of the isolation valves 214, 216, 218, 220 as well as over the valve greasing system 300. In addition to the controller 402 (e.g., which may be implemented as a single controller or multiple controllers), the control system 400 may include the valve actuators 222 (only one shown in FIG. 4), the actuation sensors 224 (only one shown in FIG. 4), and an actuation system 404. The actuation system 404 is described herein as a hydraulic system, but may be another type of system, such as a pneumatic system or an electrically actuated system. The actuation system 404 may include a plurality of fluid conduits 406 connected to the valve actuators 222. The fluid conduits 406 may be used to carry hydraulic fluid for controlling the valve actuators 222. The actuation system 404 may additionally include one or more valves (not shown), one or more pressure tanks (not shown), one or more pumps (not shown), one or more fluid reservoirs (not shown), or the like, for controlling the flow of hydraulic fluid through the fluid conduits 406.

The controller 402 may include one or more memories and one or more processors communicatively coupled to the one or more memories. A processor may include a central processing unit, a graphics processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. The processor may be capable of being programmed to perform one or more operations or processes described elsewhere herein. A memory may include volatile and/or nonvolatile memory. For example, the memory may include random access memory (RAM), read only memory (ROM), a hard disk drive, and/or another type of memory (e.g., a flash memory, a magnetic memory, and/or an optical memory). The memory may be a non-transitory computer-readable medium. The memory may store information, one or more instructions, and/or software (e.g., one or more software applications) related to the operation of the controller 402.

The valve actuators 222, the actuation sensors 224, and/or the actuation system 404 (e.g., a controller of the actuation system 404) may be communicatively coupled to the controller 402 (e.g., through a wired connection or wirelessly) to enable the transmission of information to and from the controller 402. In some examples, the controller 402 may be communicatively coupled to the controller 130 to enable the exchange of information relating to one or more pump systems 104 of the hydraulic fracturing system 100. In some examples, the controller 402 may be communicatively coupled to an operator interface (e.g., an operator interface of the automated bleed-off system 136, or an operator interface of a pump system 104 via the controller 130).

In some implementations, the automated bleed-off system 136 may include a battery 140. The battery 140 may provide a backup power source for the automated bleed-off system 136 in the event that power from an external power source (e.g., a utility grid, a generator, a solar power system, etc.) is lost. When the automated bleed-off system 136 is receiving power from the external power source, the battery 140 can be charged and one or more pressure tanks (not shown) of the actuation system 404 can be pressurized (e.g., by a pump), thus allowing the core functionality of the automated bleed-off system 136 to be continued during power outages.

The controller 402 may be configured to perform operations providing automated pressure bleed-off, automated system flushing, and/or automated valve greasing. In connection with automated pressure bleed-off, the controller 402 may receive an instruction (e.g., via an operator interface) to bleed-off pressure from the hydraulic fracturing system 100. The instruction may indicate whether the pressure is to be bled from the pump side of the hydraulic fracturing system 100 or the well side of the hydraulic fracturing system 100. The controller 402 may receive the instruction between stages of a hydraulic fracturing operation (e.g., after completion of a stage of the hydraulic fracturing operation). In other examples, the controller 402 may make a determination to bleed-off pressure from the hydraulic fracturing system 100. For example, the controller 402 may detect the completion of a stage of a hydraulic fracturing operation (e.g., based on information relating to one or more pump systems 104 received from the controller 130, such as a current discharge pressure of the pump system(s) 104), which corresponds to a time when pressure is to bled from the hydraulic fracturing system 100.

Responsive to the instruction and/or a determination to bleed-off pressure, the controller 402 may cause actuation (e.g., opening) of multiple of the isolation valves 214, 216, 218, 220 to bleed-off pressure via the multi-stage choke assembly 210 in the bleed-off line 206. For example, to bleed-off pressure from the pump side of the hydraulic fracturing system 100, the controller 130 may cause actuation (e.g., opening) of the first isolation valve 214 (allowing flow through the first fluid input 202) and actuation (e.g., opening) of the third isolation valve 218 (allowing flow through the bleed-off line 206), while the second and fourth isolation valves 216, 220 remain closed. As another example, to bleed-off pressure from the well side of the hydraulic fracturing system 100, the controller 130 may cause actuation (e.g., opening) of the second isolation valve 216 (allowing flow through the second fluid input 204) and actuation (e.g., opening) of the third isolation valve 218 (allowing flow through the bleed-off line 206), while the first and fourth isolation valves 214, 220 remain closed. In some examples, to bleed-off pressure from both the pump side and the well side of the hydraulic fracturing system 100, the controller 130 may cause actuation (e.g., opening) of the second isolation valve 216 (allowing flow through the second fluid input 204, which may also cause pressure in the pump side to equalize through the valve 132) and actuation (e.g., opening) of the third isolation valve 218 (allowing flow through the bleed-off line 206), while the first and fourth isolation valves 214, 220 remain closed. In some examples, to bleed-off pressure from both the pump side and the well side of the hydraulic fracturing system 100, the controller 130 may cause actuation (e.g., opening) of both the first isolation valve 214 and the second isolation valve 216 (e.g., concurrently), and actuation (e.g., opening) of the third isolation valve 218 (allowing flow through the bleed-off line 206), while the fourth isolation valve 220 remains closed. During a bleed-off operation, the controller 130 may monitor readings from the first pressure sensor 228 and/or the second pressure sensor 228 to detect when a target or threshold pressure (e.g., zero pressure or a wellhead pressure) is reached, at which time the controller 402 may terminate the bleed-off operation (e.g., by causing closing of the open valves).

In connection with automated system flushing, the controller 130 may receive an instruction and/or make a determination to flush the hydraulic fracturing system 100, in a similar manner as described for the automated pressure bleed-off. For example, the controller 130 may determine to flush the hydraulic fracturing system 100 based on detecting excessive proppant in the hydraulic fracturing system 100 and/or based on detecting unexpected pressures in the hydraulic fracturing system 100 (e.g., which may indicate a proppant build up). As another example, the controller 130 may determine to flush the hydraulic fracturing system 100 in connection with performing a pressure bleed-off operation. For example, the controller 130 may determine to flush the hydraulic fracturing system 100 after performing the pressure bleed-off operation.

Responsive to the instruction and/or a determination to flush the hydraulic fracturing system 100, the controller 402 may cause actuation (e.g., opening) of multiple of the isolation valves 214, 216, 218, 220 to flush fluid via the bypass line 212. For example, to flush the pump side of the hydraulic fracturing system 100, the controller 130 may cause actuation (e.g., opening) of the first isolation valve 214 (allowing flow through the first fluid input 202) and actuation (e.g., opening) of the fourth isolation valve 220 (allowing flow through the bypass line 212), while the second and third isolation valves 216, 218 remain closed. The controller 402 may terminate the flushing operation after a set time period or upon receiving an instruction to terminate the flushing operation.

The controller 130 may also execute other operations by causing actuation of one or more of the isolation valves 214, 216, 218, 220. For example, other operations may include closing all isolation valves 214, 216, 218, 220, opening all isolation valves 214, 216, 218, 220 (e.g., for transport or rig down), priming the bleed-off manifold 200 to a test pressure, performing a pressure test of the bleed-off manifold 200 (e.g., to check for leaks), and/or a combination operation that includes the prime up, the pressure test, and a bleed-off to the wellhead. In connection with one or more of these operations, the controller 130 may monitor pressure at the first pressure sensor 228, the second pressure sensor 228, and/or the third pressure sensor 228 (e.g., monitor pressure increases, pressure drops, pressure differentials, or the like).

In connection with automated valve greasing, the controller 130 may monitor, using the actuation sensors 224, respective valve actuation histories for each of the isolation valves 214, 216, 218, 220, and the controller 130 may cause, based on the valve actuation histories, one or more of the isolation valves 214, 216, 218, 220 to be greased using the valve greasing system 300. For example, the controller 130 may keep a count of the number of times each of the isolation valves 214, 216, 218, 220 has been actuated (e.g., opened and/or closed) since a previous greasing. Following an operation involving actuation of an isolation valve 214, 216, 218, 220, as described herein, the controller 130 may determine whether the count of the number of actuations for that isolation valve meets a threshold (e.g., six actuations), thereby indicating that greasing is needed. If the count meets the threshold, then the controller 130 may cause the isolation valve to be greased using the valve greasing system 300. In particular, the controller 130 may cause the pump 306 of the valve greasing system 300 to pump grease through a grease conduit 304 to the isolation valve. In some examples, the controller 130 may cause actuation of the isolation valve (e.g., repetitive opening and closing) during greasing to improve an application of the grease. In some examples, all of the isolation valves 214, 216, 218, 220 may be greased if any one of the isolation valves is due for greasing.

As indicated above, FIG. 4 is provided as an example. Other examples may differ from what is described with regard to FIG. 4.

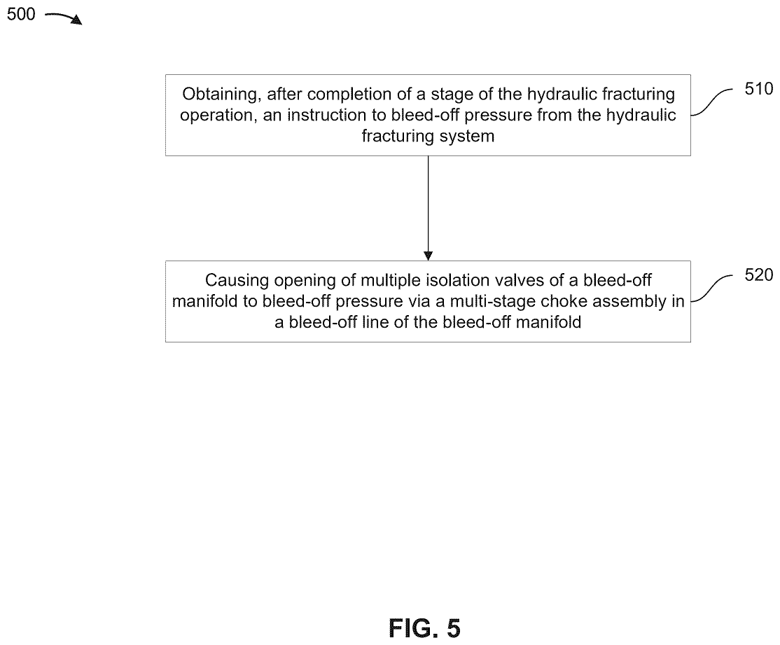

FIG. 5 is a flowchart of an example process 500 associated with automated pressure bleed-off. One or more process blocks of FIG. 5 may be performed by a controller (e.g., controller 402). Additionally, or alternatively, one or more process blocks of FIG. 5 may be performed by another device or a group of devices separate from or including the controller, such as another device or component that is internal or external to the automated bleed-off system 136 (e.g., controller 130). Process 500 may relate to automated bleed-off of fluid pressure from a hydraulic fracturing system between stages of a hydraulic fracturing operation.

Process 500 may include, at step 510, obtaining (e.g., using one or more memories, one or more processors, and/or a communication component of controller 402), after completion of a stage of the hydraulic fracturing operation, an instruction to bleed-off pressure from the hydraulic fracturing system.

Process 500 may include, at step 520, causing (e.g., using one or more memories, one or more processors, a communication component of controller 402, and/or a valve actuator 222) opening of multiple isolation valves of a bleed-off manifold to bleed-off pressure via a multi-stage choke assembly in a bleed-off line of the bleed-off manifold.

In some examples, process 500 may further include monitoring (e.g., using one or more memories, one or more processors of controller 402, and/or an actuation sensor 224) a valve actuation history of an isolation valve, and causing (e.g., using one or more memories, one or more processors, and/or a communication component of controller 402), based on the valve actuation history, the isolation valve to be greased using a valve greasing system that includes a grease conduit fluidly coupled to the isolation valve. In some examples, process 500 may further include causing (e.g., using one or more memories, one or more processors, and/or a communication component of controller 402) opening of different multiple isolation valves of the bleed-off manifold to flush fluid through a bypass line of the bleed-off manifold that bypasses the multi-stage choke assembly.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

### INDUSTRIAL APPLICABILITY

The automated bleed-off system 136 described herein may be used with any system that contains high-pressure fluid. For example, the automated bleed-off system 136 may be used with a hydraulic fracturing system for recovery of water, oil, natural gas, and/or other fluids from a rock formation. In a hydraulic fracturing operation, pressurized fluid and proppants may be pumped into the wellbore in a series of stages. Following a stage, the pressurized fluid may be bled from the system to allow for various wireline activities to be performed in the wellbore. Generally, in a bleed-off operation, one or more valves are manually opened and closed when a target pressure is reached. This manual approach is imprecise and inconsistent, which can lead to unintended rapid depressurization and damage to components of the hydraulic fracturing system. Moreover, the valves should receive frequent greasing to improve their longevity. However, a timing for greasing the valves is often subject to operator discretion, which can result in lengthy intervals between greasings that can shorten a useful life of the valves.

The automated bleed-off system 136 described herein provides automated pressure bleed-off as well as automated valve greasing. In particular, the automated bleed-off system 136 may perform a pressure bleed-off using a sequence of valve openings with high precision and consistency. This high precision and consistency of the automated pressure bleed-off reduces unintended rapid depressurization events, thereby preventing damage and extending the useful life of components of a hydraulic fracturing system. Moreover, the bleed-off manifold 200 of the automated bleed-off system 136 includes a multi-stage choke assembly 210 that provides a gradual pressure release that reduces stress on components of the hydraulic fracturing system and extends a useful life of the chokes of the multi-stage choke assembly 210. In addition, the automated bleed-off system 136 may perform valve greasing at regular intervals, thereby ensuring proper greasing of valves and extending their useful lives.

The foregoing describes only some embodiments, and alterations, modifications, additions and/or changes can be made thereto without departing from the scope and spirit of the disclosed embodiments, the embodiments being illustrative and not restrictive. Furthermore, implementations are not limited to the disclosed embodiments, and may cover various modifications and equivalent arrangements included within the spirit and scope of the disclosed embodiments. Also, the various embodiments described above may be implemented in conjunction with other embodiments, for example, aspects of one embodiment may be combined with aspects of another embodiment to realize yet other embodiments. Further, each independent feature or component of any given assembly or process may constitute an additional embodiment. As used herein, the singular forms of “a,” “an,” and “the” include plural referents unless the context clearly dictates otherwise. In addition, as used herein, the term “or” means “and/or” unless the context clearly dictates otherwise.

When “a controller” or “one or more controllers” is described or claimed (within a single claim or across multiple claims) as performing multiple operations or being configured to perform multiple operations, unless described or claimed otherwise (e.g., via the use of “first controller” and “second controller” or other language that differentiates controllers) this language is intended to cover a single controller performing or being configured to perform all of the operations, a group of controllers collectively performing or being configured to perform all of the operations, a first controller performing or being configured to perform a first operation and a second controller performing or being configured to perform a second operation, or any combination of controllers performing or being configured to perform the operations.

What is claimed is:

1. An automated bleed-off system for a hydraulic fracturing system, comprising:
a bleed-off manifold, comprising:
one or more fluid inputs to receive pressurized fluid from the hydraulic fracturing system;
a bleed-off line fluidly coupling the one or more fluid inputs to an output; and
a plurality of isolation valves to control flow through the one or more fluid inputs and the bleed-off line;
a valve greasing system, comprising:
a grease reservoir to hold grease; and
a grease conduit fluidly coupling the grease reservoir to an isolation valve of the plurality of isolation valves; and
a control system, comprising:
a valve actuator, comprising an actuation sensor, to control actuation of the isolation valve; and
a controller configured to cause actuation of one or more of the plurality of isolation valves to bleed-off pressure via the bleed-off line.

2. The automated bleed-off system of claim 1, wherein the controller is configured to cause actuation responsive to receiving an instruction between stages of a hydraulic fracturing operation.

3. The automated bleed-off system of claim 1, wherein the controller is further configured to:
monitor, using the actuation sensor, a valve actuation history of the isolation valve; and
cause, based on the valve actuation history, the isolation valve to be greased using the valve greasing system.

4. The automated bleed-off system of claim 3, wherein the controller, to cause the isolation valve to be greased, is configured to cause pumping of a pump configured to pump the grease from the grease reservoir through the grease conduit.

5. The automated bleed-off system of claim 1, wherein the bleed-off line comprises a multi-stage choke assembly.

6. The automated bleed-off system of claim 1, further comprising:
a bypass line fluidly coupling the one or more fluid inputs to the output,
wherein the bypass line bypasses the bleed-off line.

7. The automated bleed-off system of claim 6, wherein the controller is further configured to cause actuation of one or more of the plurality of isolation valves to flush fluid via the bypass line.

8. The automated bleed-off system of claim 1, wherein the one or more fluid inputs comprise:
a first fluid input to receive pressurized fluid from a pump side of the hydraulic fracturing system,
wherein the pump side is upstream of a valve, in a conduit of the hydraulic fracturing system, that is between one or more pumps and one or more wells of the hydraulic fracturing system; and
a second fluid input to receive pressurized fluid from a well side of the hydraulic fracturing system,
wherein the well side is downstream of the valve.

9. A bleed-off manifold for a hydraulic fracturing system, comprising:
a first fluid input to receive pressurized fluid from a pump side of the hydraulic fracturing system,
wherein the pump side is upstream of a valve, in a conduit of the hydraulic fracturing system, that is between one or more pumps and one or more wells of the hydraulic fracturing system;
a second fluid input to receive pressurized fluid from a well side of the hydraulic fracturing system,
wherein the well side is downstream of the valve;
a bleed-off line fluidly coupling the first fluid input and the second fluid input to an output,
wherein the bleed-off line comprises a multi-stage choke assembly;
a bypass line fluidly coupling the first fluid input and the second fluid input to the output,
wherein the bypass line bypasses the multi-stage choke assembly;
a first isolation valve to control flow through the first fluid input;
a second isolation valve to control flow through the second fluid input;
a third isolation valve to control flow through the bleed-off line; and
a fourth isolation valve to control flow through the bypass line.

10. The bleed-off manifold of claim 9, further comprising:
a first pressure sensor between the first fluid input and the first isolation valve; and
a second pressure sensor between the second fluid input and the second isolation valve.

11. The bleed-off manifold of claim 10, further comprising:
a third pressure sensor between the first isolation valve and the second isolation valve.

12. The bleed-off manifold of claim 9, wherein the multi-stage choke assembly comprises a first choke and a second choke in series.

13. The bleed-off manifold of claim 12, wherein the first choke has an elbow configuration, and the second choke has an in-line configuration.

14. The bleed-off manifold of claim 9, further comprising a connection conduit,
wherein the first fluid input and the second fluid input are fluidly coupled to an input end of the connection conduit, and
wherein the bleed-off line and the bypass line are fluidly coupled to an output end of the connection conduit.

15. The bleed-off manifold of claim 9, further comprising:
a first valve actuator, comprising a first actuation sensor, to control actuation of the first isolation valve;
a second valve actuator, comprising a second actuation sensor, to control actuation of the second isolation valve;
a third valve actuator, comprising a third actuation sensor, to control actuation of the third isolation valve; and
a fourth valve actuator, comprising a fourth actuation sensor, to control actuation of the fourth isolation valve.

16. A method for automated bleed-off of fluid pressure from a hydraulic fracturing system between stages of a hydraulic fracturing operation, comprising:
obtaining, by a controller and after completion of a stage of the hydraulic fracturing operation, an instruction to bleed-off pressure from the hydraulic fracturing system; and
causing, by the controller, opening of multiple isolation valves of a bleed-off manifold to bleed-off pressure via a multi-stage choke assembly in a bleed-off line of the bleed-off manifold.

17. The method of claim 16, further comprising:
causing, by the controller and based on a valve actuation history for an isolation valve of the multiple isolation valves, the isolation valve to be greased using a valve greasing system that includes a grease conduit fluidly coupled to the isolation valve.

18. The method of claim 17, further comprising:
monitoring, using an actuation sensor of the isolation valve, the valve actuation history of the isolation valve.

19. The method of claim 16, further comprising:
causing, by the controller, opening of different multiple isolation valves of the bleed-off manifold to flush fluid through a bypass line of the bleed-off manifold that bypasses the multi-stage choke assembly.

20. The method of claim 16, wherein causing the opening of the multiple isolation valves comprises:
causing opening of an isolation valve, of the multiple isolation valves, that controls flow through a fluid input of the bleed-off manifold; and
causing opening of another isolation valve, of the multiple isolation valves, that controls flow through the bleed-off line.
